(19) United States
(12) Patent Application Publication
(10) Pub. No.: US 2020/0010210 A1
(43) Pub. Date: Jan. 9, 2020

(54) AIRCRAFT

(71) Applicant: Dr. Ing. h.c. F. Porsche Aktiengesellschaft, Stuttgart (DE)

(72) Inventor: Thomas Warbeck, Lauffen am Neckar (DE)

(73) Assignee: Dr. Ing. h.c. F. Porsche Aktiengesellschaft, Stuttgart (DE)

(21) Appl. No.: 16/460,437

(22) Filed: Jul. 2, 2019

(30) Foreign Application Priority Data
Jul. 4, 2018 (DE) 102018116144.1

(51) Int. Cl. B64D 33/10; B64D 13/00; B64D 27/24

(52) U.S. Cl. CPC B64D 33/10; B64D 27/24; B64D 13/006

(57) ABSTRACT

An aircraft includes electrical components and a ducted fan with a cooling coil. The aircraft is designed to discharge heat from the electrical components to the cooling coil.

### CROSS-REFERENCE TO RELATED APPLICATION

This application claims priority to German Patent Application No. 10 2018 116 144.1, filed Jul. 4, 2018, the content of such application being incorporated by reference herein in its entirety.

### FIELD OF THE INVENTION

The present invention relates to an aircraft, in particular a fully electric vertical take-off and landing (VTOL) aircraft.

### BACKGROUND OF THE INVENTION

VTOL is the cross-language name given in the aerospace industry to any type of aircraft, drone or rocket which has the capability to take off and land again substantially vertically and without a runway. This collective term is used below in a broad sense which includes not only fixed-wing aircraft with wings, but rather also rotary-wing aircraft such as helicopters, gyrocopters, gyrodynes and hybrids such as composite or combination helicopters and convertiplanes. Furthermore, short take-off and landing (STOL) aircraft, short take-off and vertical landing (STOVL) aircraft or vertical take-off and horizontal landing (VTHL) aircraft are included.

US20160273448A1, which is incorporated by reference herein, discloses a ducted fan turbine engine. The engine comprises an oil circuit with an air/oil cooler. In order to increase the capacity of the cooler, the cooler is equipped with an apparatus for injecting water. The thermal capacity of the water intensifies the cooling, while the removal of the water by suction increases the thrust of the turbine engine.

CN206939095U, which is incorporated by reference herein, appears to disclose a similar apparatus.

### SUMMARY OF THE INVENTION

One benefit of the aircraft described herein is the ability to provide efficient cooling without aerodynamic losses which is created.

The aircraft may therefore be equipped, for instance, with bent or even selectively bendable wings. A corresponding variant increases the effective wing surface during horizontal flight, without however increasing the footprint of the aircraft.

Furthermore, the aircraft may have a fast-charging battery system which provides the drive energy for vertical take-off and landing and also horizontal flight and allows quick charging of the aircraft when stationary.

In this case, instead of freely moving rotors, a plurality of ducted fans, including of different sizes, as are known outside of the aerospace industry, for instance for hovercraft or airboats, may be used to drive the aircraft. The cylindrical housing surrounding the fan may considerably reduce the thrust losses caused by vortexes at the blade tips in an embodiment of said kind. Suitable ducted fans may be aligned horizontally or vertically, designed so as to be able to pivot between both positions or be covered by louvers during horizontal flight for aerodynamic reasons. In addition, pure horizontal thrust generation using fixed ducted fans is conceivable.

In addition to preferably fully autonomous operation of the aircraft—it is also possible to consider granting manual control to human pilots if they are sufficiently qualified, this giving the apparatus according to aspects of the invention the greatest possible degree of flexibility in terms of handling.

Details of the wings may be disclosed in U.S. Pat. No. 2,712,421, and further details of the propellers and rotors may be disclosed in U.S. patent Ser. No. 10/131,426, each of which is incorporated by reference herein in its entirety.

### BRIEF DESCRIPTION OF THE DRAWING

One exemplary embodiment of the invention is illustrated in the drawing and will be described in more detail below.

FIG. 1 shows the partial cross section through an aircraft according to aspects of the invention.

FIG. 2 depicts an isometric view of an aircraft, wherein the wings are shown in an extended configuration and the rear propellers are shown in an angled orientation.

FIG. 3 depicts a front elevation view of the aircraft of FIG. 2, wherein the wings are shown extended configuration and the rear propellers are shown in a cruising orientation.

FIG. 4 depicts another front elevation view of the aircraft, wherein the wings are shown in a folded configuration and the rear propellers are shown in a take-off/landing orientation.

FIG. 5 depicts a top plan view of a portion of an aircraft, showing an internal duct extending between a nose of the aircraft and a horizontal fan mounted to the wing.

FIG. 6 depicts moveable louvers applied on top of the horizontal fan of FIG. 5, wherein the louvers are shown in a closed position.

FIG. 7 depicts the movable louvers of FIG. 6, wherein the louvers are shown in an open position.

### DETAILED DESCRIPTION OF THE INVENTION

The terms ‘fan,’ ‘rotor’ and ‘propeller’ may be used interchangeably herein.

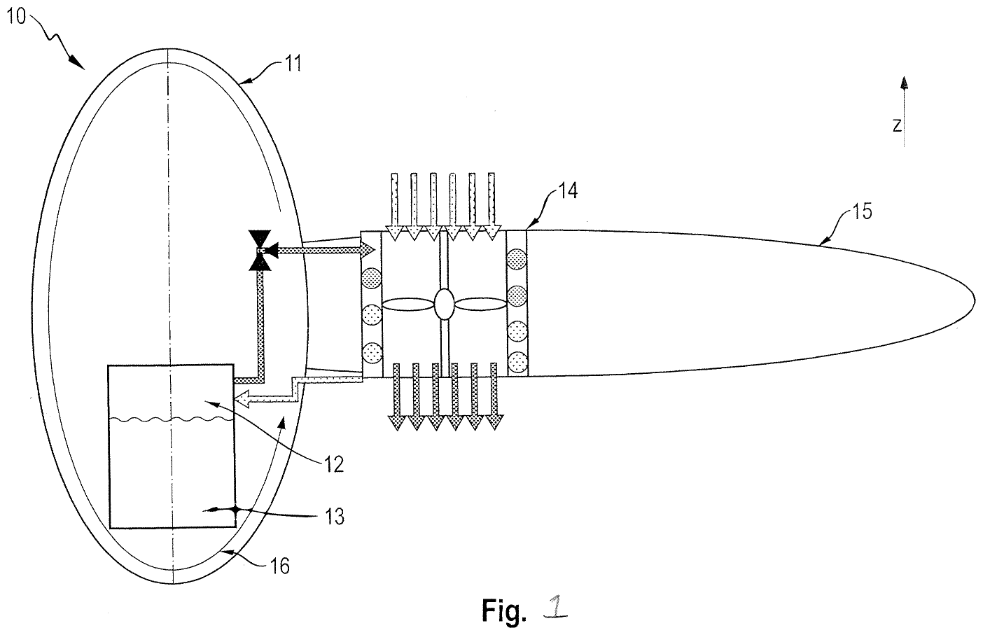

FIG. 1 illustrates the structural features of a vertical take-off and landing aircraft 10 which is equipped with a ducted fan 14 which is integrated in the wing 15. The maximum power requirement and therefore the maximum cooling requirement occurs during vertical flight; however, in this flight phase, the lowest cooling power can be achieved by means of the convection on the outer skin of the aircraft 10 since the relative speed between the ambient air and the aircraft 10 is low. Therefore, according to aspects of the invention, the high air speeds in the region of the ducted fan 14 which is active during take-off and landing are utilized by way of a cooling structure being introduced into the duct structure. Here, the surface can be designed to be largely smooth—and therefore aerodynamically optimum—by laminating the cooling structure in composite fiber or to have cooling ribs for maximizing the cooling power. Heat-transfer liquid flows through the cooling structure, which heat-transfer liquid draws heat from liquid-cooled components such as the high-voltage battery 13, converter 12 and any electric motors and discharges 1i said heat again via the duct cooler.

During horizontal flight, the liquid is not guided through the ducted fans 14 but rather extensively through the fuselage 11 or wings 15 of the aircraft 10. As a result, the heat-transferring surface area can be maximized and the waste heat produced during horizontal flight can be discharged to the surrounding area. The cooling structure used for this purpose can likewise be incorporated by lamination or else connected in a thermally contacting manner to filler or other interface materials on the inner skin of the fuselage 11 or the wings 15. During the transition to vertical landing, a changeover is again made to duct cooling.

Appropriate cooling without a significant increase in the air resistance can be provided in this way.

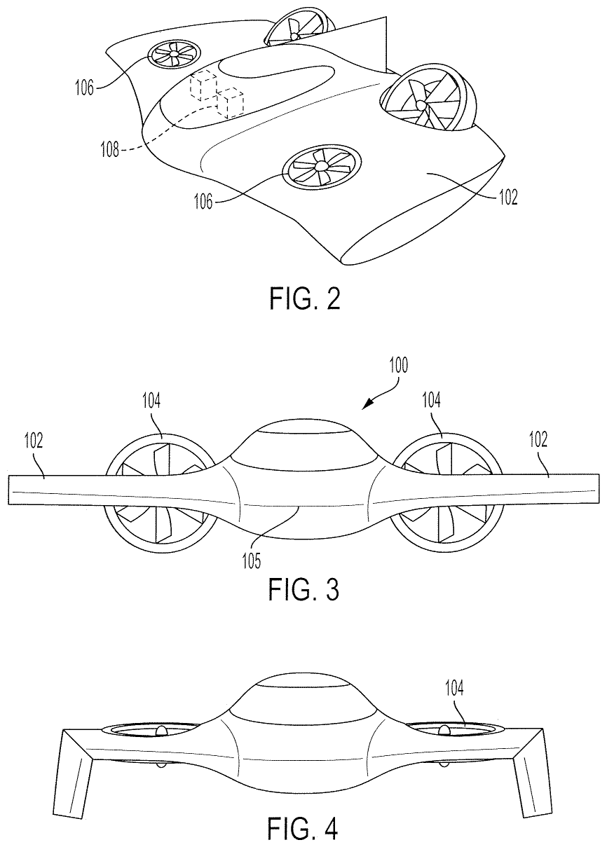

FIGS. 2-4 depict an aircraft 100. The aircraft 100 shown in those figures may appear different from the previously described aircraft, however, most (if not all) of the details of the previously described aircraft also apply to aircraft 100.

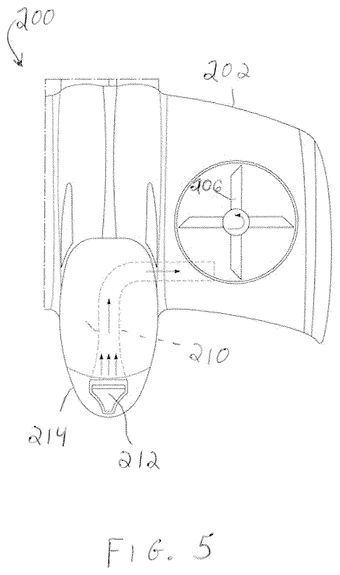

The aircraft 100 includes foldable wings 102. The wings 102 are shown in a folded configuration in FIG. 4 and an extended configuration in FIG. 3. A motor or solenoid is configured to move the wings between those configurations.

Rear propellers 104 are mounted on the trailing edge of the airfoils or wings 102 (i.e., the edge furthest from the nose 105). Propellers 104 may be referred to as cruising propellers because they are used during the cruising operation of the aircraft (at least in one position of the propellers 104). The propellers 104 are configured to pivot between two different positions, as shown in FIGS. 2-4. In the vertical position of the propellers 104 shown in FIG. 3, the propellers 104 generate maximum horizontal thrust for cruising operation of the aircraft (i.e., while the aircraft is flying through the air). In the horizontal position of the propellers 104 shown in FIG. 4, the propellers 104 generate maximum vertical thrust for take-off and landing operations of the aircraft. A motor or solenoid is configured to move the propellers 104 between those two positions. Alternatively, the propellers 104 may be immovable and fixed in a vertical position, as shown in FIG. 2.

Horizontally mounted propellers 106 are fixedly mounted and integrated into the wings 102. Unlike the propellers 104, the position of the propellers 106 is fixed, however, those skilled in the art will recognize that the propellers 106 could be modified so that they are pivotable between vertical and horizontal positions. The propellers 106 generate maximum vertical thrust for take-off and landing operations of the aircraft. The propellers 106 may also be referred to herein as lifting propellers.

The propellers 104 and 106, which may also be referred to herein as fans, may be operated by a fully-electric drive. To that end, a battery charging system 108 including a charger, an inverter and a fast-charging battery are positioned within the fuselage of the aircraft for powering the propellers 104 and 106. The fuselage may also be configured to carry one or more passengers.

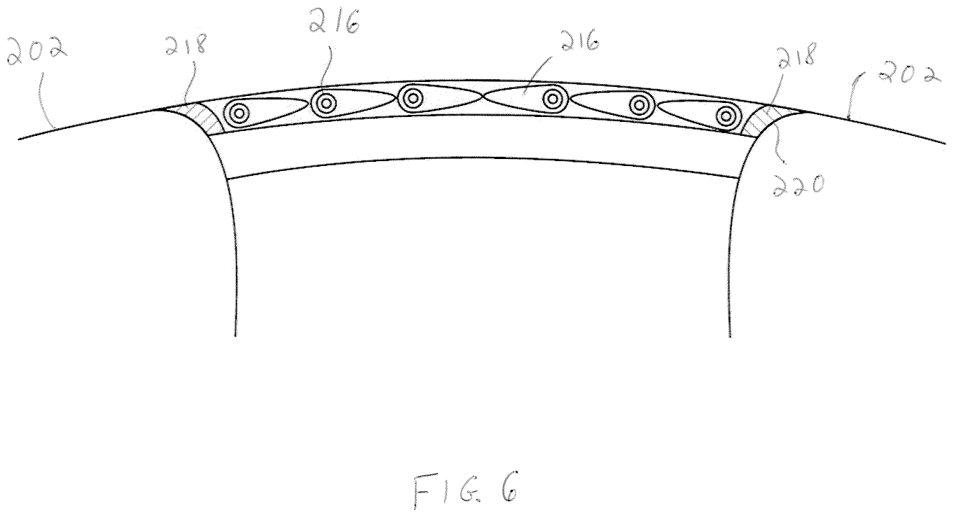

FIGS. 5-7 depict views of an aircraft 200. The aircraft 200 shown in those figures may appear different from the previously described aircraft 100, however, most (if not all) of the details of the previously described aircraft 100 also apply to aircraft 200. Only a segment of the aircraft 200 is shown in FIG. 5. An air duct 210 extends between an opening 212 formed on the nose 214 of the aircraft 200 and the horizontally mounted propeller 206 that is fixedly mounted to the wing 202. In operation, air is delivered to the propeller 206 via the duct 210, as depicts by the arrows. Although not shown, air ducts that are similar to duct 210, may extend to the propeller 206 on the opposite wing 202, as well as any rear propellers 104 (not shown in these views). Accordingly, the propellers may be referred to as either “ducted propellers” or “ducted fans.”

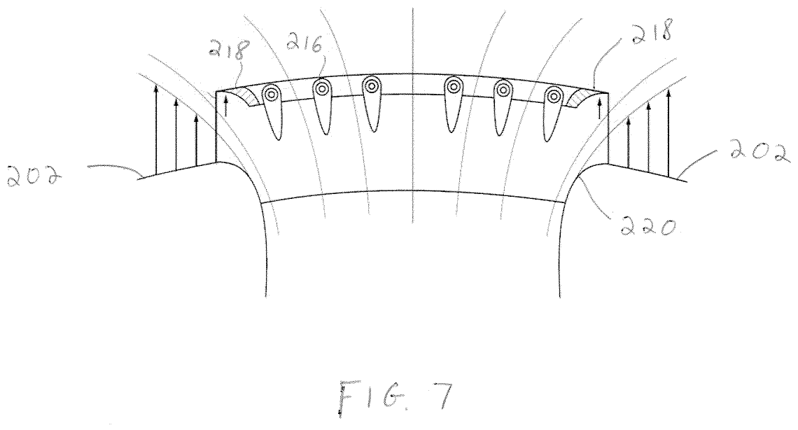

FIGS. 6 and 7 depict louvers 216 that are configured to selectively cover the horizontally mounted propellers 206. It is noted that the louvers 216 are omitted from FIG. 5 for clarity purposes. Each louver 216 is rotatable about a shaft (or otherwise moveable) between a closed position (FIG. 6) and an open position (FIG. 7). The louvers 216, which are flush with the top face of the wing 202, may be moved to the closed position during the cruising operation of the aircraft 200 for aerodynamic purposes. The louvers 216 may be moved to an open position at any time during operation of the propellers 206 to permit the exit or entrance of air therethrough. A motor or solenoid is configured to move the louvers 216 between those positions. It is noted that the louvers are shown in a closed position in FIG. 2.

A sealing ring 218 surrounds the louvers 216 and is moveable between a retracted position (FIG. 6) and a deployed position (FIG. 7). The louvers 216 are mounted to the sealing ring 218 and move therewith between the retracted and deployed positions. The lower surface of the sealing ring 218 is configured to be in sealing relationship with an opening 220 formed in the wing 202. It should be understood that the opening 220 accommodates the body of the propeller 206. The sealing ring 218 may be moved to the retracted position, which is flush with the top face of the wing 202, during cruising operation of the aircraft 200 for aerodynamic purposes. Alternatively, the sealing ring 218 may be moved to the deployed (i.e., extended) position at any time during operation of the propellers 206 to permit the exit or entrance of air, as depicted by the arrows in FIG. 7. A motor or solenoid is configured to move the sealing ring 218 between those positions.

What is claimed is:

1. An aircraft comprising electrical components and a ducted fan with a cooling coil, wherein the aircraft is configured to discharge heat from the electrical components to the cooling coil.

2. The aircraft as claimed in claim 1, further comprising a fuselage and a wing, wherein the electrical components are arranged in the fuselage and the ducted fan is arranged in the wing

3. The aircraft as claimed in claim 1, wherein the electrical components comprise an inverter and a battery.

4. The aircraft as claimed in claim 1, wherein the aircraft has a fully electric drive.

5. The aircraft as claimed in claim 1, wherein the aircraft comprises bent or bendable wings.

6. The aircraft as claimed in claim 1, wherein the aircraft comprises a battery charging system.

7. The aircraft as claimed in claim 1, wherein the aircraft comprises horizontally fixed ducted fans, which are configured for use during take-off and landing.

8. The aircraft as claimed in claim 7, wherein the aircraft has louvers and the horizontal ducted fans can be selectively covered by the louvers.

9. The aircraft as claimed in claim 1, wherein the aircraft comprises vertically fixed ducted fans for generating propulsion.

10. The aircraft as claimed in claim 1, wherein the aircraft can be selectively fully autonomously controlled.
